(19) United States
(12) Patent Application Publication
(10) Pub. No.: US 2026/0155062 A1
(43) Pub. Date: Jun. 4, 2026

(54) INTERACTIVE TRAINING APPARATUS

(71) Applicant: Stryker Corporation, Portage, MI (US)

(72) Inventors: Adam Harvey, Hillsborough (IE); Allister McIntyre, Newtownards (IE); Olibhéar McAlister, Belfast (IE); Ben McCartney, Carrickfergus (IE)

(73) Assignee: Stryker Corporation, Portage, MI (US)

(21) Appl. No.: 19/406,577

(22) Filed: Dec. 2, 2025

Related U.S. Application Data
(60) Provisional application No. 63/727,469, filed on Dec. 3, 2024.

(51) Int. Cl. G09B 23/28

(52) U.S. Cl. CPC G09B 23/288

(57) ABSTRACT

Systems, devices, and methods for determining and detecting a simulated physiological parameter that includes a treatment artifact are described herein. In an example method, the treatment artifact is determined based on identifying a treatment administered to a housing. An artifacted physiological parameter is determined based on the treatment artifact and parameter data that is indicative of a physiological parameter sampled over a time interval. A physical signal indicative of the artifacted physiological parameter is outputted to the housing. The example method can be implemented in a training apparatus, a manikin, a module, or a medical device. Together, the systems, devices, and methods can improve evaluation of medical devices and training opportunities by providing more realistic simulations of medical scenarios.

### CROSS-REFERENCE TO RELATED APPLICATION

This application claims priority to and the benefit of the earlier filing of U.S. Provisional Application No. 63/727,469, filed on Dec. 3, 2025, which is incorporated by reference herein in its entirety.

### BACKGROUND

Simulations of emergency medical situations are often used to demonstrate product capabilities and provide training opportunities. Trainees can practice medical techniques, such as cardiopulmonary resuscitation (CPR), on a manikin in these simulations. CPR is an emergency medical procedure to maintain blood circulation and oxygenation in a patient suffering from cardiac arrest. CPR includes repeatedly administering chest compressions to pump blood through the body. Chest compressions can be delivered manually or by mechanical chest compression devices (MCCDs). During a training exercise, the manikin may be connected to one or more medical devices, such as a monitor-defibrillator, that outputs a simulated physiological parameter of a patient.

### BRIEF DESCRIPTION OF THE DRAWINGS

FIG. 1 illustrates an example environment in which a treatment is being administered to a training apparatus.

FIG. 2 illustrates an example simulated ECG associated with a training apparatus.

FIG. 3 illustrates an example process for generating an artifacted signal based on a force administered to a training apparatus.

FIG. 4 illustrates an example process for outputting, to a housing, a physical signal corresponding to a simulated physiological signal.

FIG. 5 illustrates an example of an external defibrillator configured to perform various functions described herein.

FIG. 6 illustrates a chest compression device configured to perform various functions described herein.

### DETAILED DESCRIPTION

Various implementations described herein relate to systems, devices, and methods for determining and detecting a simulated physiological parameter, such as for use in a medical training exercise. Various methods described herein include determining a treatment artifact based on identifying a medical treatment administered to a training apparatus, such as a manikin. Accordingly, an artifacted physiological parameter is generated, based on the treatment artifact and simulated physiological parameter data, which accurately corresponds to the treatment being administered to the training apparatus, enabling realistic feedback for users in a medical training exercise. For instance, implementations enable the determination of treatment decisions or other recommendations by a medical device or by a user based on the artifacted physiological parameter.

In various implementations, a physical signal indicative of the artifacted physiological parameter or the simulated physiological parameter data is output to a housing of the training apparatus. Various methods described herein detect the physical signal from the housing of the training apparatus. Accordingly, proper use and positioning of sensors can be determined using implementations described herein.

Implementations of the present disclosure are directed to specific improvements in the technical field of medical training and simulation. In particular, implementations of the present disclosure improve simulations of emergency medical situations. The use of various implementations described herein can provide realistic simulations of medical scenarios, enable better training experiences, and allow for practical evaluation of devices and systems in medical simulations. For instance, implementations of the present disclosure relate to determining and detecting simulated physiological parameter data that is indicative of treatment being administered to a training apparatus. Accordingly, trainees and participants in emergency medical situation simulations can be provided with more realistic scenarios and training experiences, thereby more effectively preparing them for real-world medical emergencies.

Implementations of the present disclosure will now be described with reference to the accompanying figures.

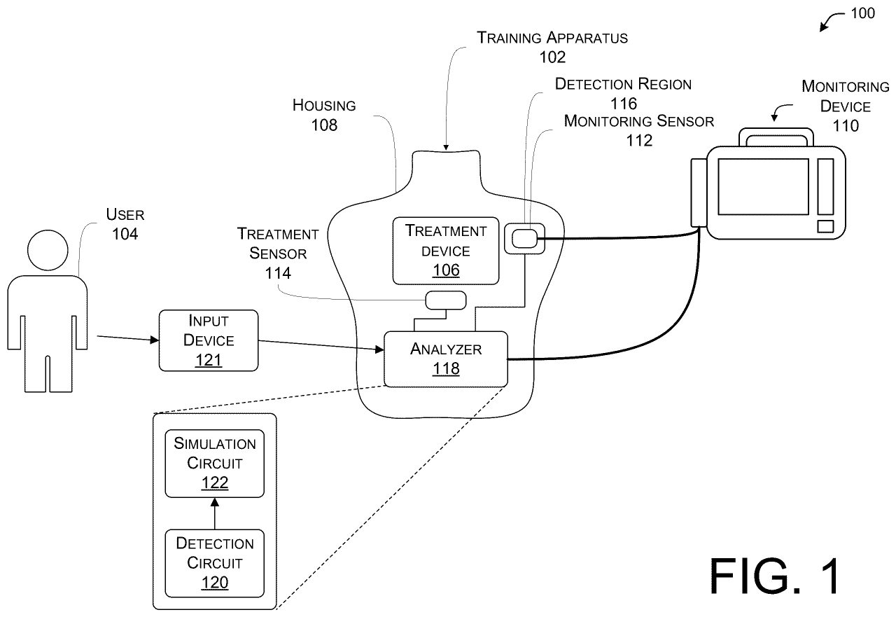

FIG. 1 illustrates an example environment 100 in which a treatment is being administered to a training apparatus 102. The training apparatus 102, for instance, includes a manikin. In some examples, the treatment includes chest compressions, an electrical shock (e.g., suitable for defibrillation), pacing pulses, assisted ventilation, or another medical treatment. The treatment, in some examples, is administered by a user 104 (e.g., a medical student, an emergency medical technician (EMT) trainee, a cardiopulmonary resuscitation (CPR) certification participant, a participant in a medical simulation, etc.) or by a treatment device 106 (e.g., a defibrillator, a chest compression device, a mechanical ventilator, or another medical device).

The training apparatus 102 includes a housing 108 that is configured to withstand the treatment. “Withstand” and its equivalents, as used herein, refer to the ability of an object to return to its original state and/or maintain function following an external stimulus. For instance, an object configured to withstand a compressive force may deform in response to the compressive force and return to its state prior to the compressive force. In some examples, an object configured to withstand an electrical shock may include a material that is resistant to melting or burning due to the electrical shock. In some examples, an object configured to withstand an electrical shock may include one or more surge protective devices that can, for instance, shield electronic components of the object from the electrical shock. Accordingly, the object and, in some cases, the included electronic components may continue to function after the electrical shock. In various cases, the housing 108 has an elasticity configured to withstand chest compressions. For instance, the housing 108 has a Young's modulus in a range of 1 to 10 gigapascal (GPa). In some instances, the housing 108 has an elasticity configured to withstand assisted ventilation. In some examples, the housing 108 includes a material with an electrical conductivity configured to withstand an electrical shock suitable for defibrillation (e.g., an electrical shock with an energy level up to 720 J without permanent damage. For instance, the housing 108 may include a material with an electrical impedance in a range of 20 to 230 Ohms. In some cases, the housing 108 may include a material with an electrical conductivity in a range of 10⁻²³ to 10⁻¹ Siemens per minute (S/m) at 20° C. In various examples, the housing 108 is electrically connected to surge protective device configured to absorb the electrical shock. The surge protective device may include at least one of: a resistor (e.g., a voltage dependent resistor), a diode (e.g., a transient voltage suppressor), a fuse, or the like.

In various examples, a shape of the training apparatus 102 includes a shape of a human body. For instance, the shape of the training apparatus 102 may include a shape of a human torso, a shape of another region of the human body, or a shape of an entire human body.

In some examples, a monitoring device 110 is configured to output a simulated physiological parameter corresponding to the training apparatus 102. In some examples, the monitoring device 110 is a training device that is not used with human patients. “Simulated physiological parameter,” as used herein, refers to synthetic data or a synthetic signal that represents a physiological parameter. For instance, the synthetic data represents a physiological parameter sampled over a time interval The simulated physiological parameter may be generated, for instance, by a signal generator, a microcontroller, or the like. The simulated physiological parameter, in various cases, represents at least one of an electrocardiogram (ECG), a blood oxygen saturation (SpO2), a regional saturation of oxygen (rSO2), a blood flow parameter (e.g., a blood pressure, a blood flow rate, a stroke volume, or the like), a pulse rate, an airway parameter (e.g., such as a respiratory rate, an end-tidal CO₂, a carbon dioxide (CO₂) partial pressure, a CO₂ fraction, a flow rate, a net forward flow, an inspiratory or expiratory pressure, or another airway parameter), a transthoracic impedance, a phonocardiogram, or another physiological parameter.

The monitoring device 110 includes, for instance, a monitoring sensor 112 configured to be disposed on the training apparatus 102. The monitoring sensor 112 includes a training sensor that can be operated similarly to a medical sensor suitable for patient monitoring (e.g., an ECG electrode, a blood pressure monitor, a pulse oximeter, a transcutaneous monitor, a heart rate monitor, a capnometer, a flow meter, or another medical sensor configured to detect the physiological parameter). For example, the physical appearance of the training sensor may be similar to the physical appearance of the medical sensor.

In various cases, it may be beneficial to provide feedback, to the user 104, on the operation of the monitoring sensor 112 and/or the treatment administration during a training exercise. For instance, conventional monitoring devices that are used for training and/or simulation may be configured to output the simulated physiological parameter based on receiving an indication that the monitoring sensor 112 has been placed on the training apparatus 102. In some examples, a supervisor (e.g., a medical educator, a trained user, etc.) may provide, to the monitoring device 110, an indication that the user 104 has placed the monitoring sensor 112 on the housing 108.

In various instances, however, it may be difficult for the supervisor to determine whether the monitoring sensor 112 is securely positioned on the housing 108. In some examples, it is difficult for the supervisor to determine whether the user 104 is administering the treatment to the training apparatus 102 properly. For instance, the supervisor may not be able to determine whether a depth, a frequency, and a position of chest compressions administered, to the training apparatus 102 by the user 104, are satisfactory.

Using previous techniques, the simulated physiological parameter has been previously recorded from, or generated based on a physiological parameter recorded from, of one or more patients. However, if the simulated physiological parameter has been generated using previous techniques, it may not accurately represent the training environment. For instance, due to the supervisor confirming correct placement of the monitoring sensor 112, the simulated physiological parameter may not be instantaneously output, by the monitoring device 110, after the monitoring sensor 112 is placed on the training apparatus 102. In some examples, the simulated physiological parameter generated using previous techniques is not be indicative of the treatment being administered. For instance, administration of chest compressions to a patient causes a compression artifact in an ECG collected from a real-world patient, but such an artifact is not present in a simulated ECG generated using previous techniques. Determining, for instance, whether to administer a defibrillation shock based on an ECG with a compression artifact may be more difficult that determining whether to administer the defibrillation shock based on a simulated ECG without the artifact. The absence of the artifact can significantly reduce the quality of the training exercise and the preparedness of the user 104 for a real-world medical emergency.

In some cases, a predetermined simulated treatment artifact can be added to a simulated physiological parameter. However, this technique has its own problems. The predetermined simulated treatment artifact, for instance, does not accurately represent the parameters (e.g., frequency, time, magnitude, etc.) of the treatment being performed by the user 104 or the treatment device 106. Accordingly, conventional training and simulation environments may not accurately reflect the pace and complexity of an emergency medical situation.

In some examples, these issues can be addressed by using a treatment sensor 114 to identify the treatment being administered to the training apparatus 102 during the training exercise. The treatment sensor 114 can be used, in various cases, to determine a treatment artifact that accurately represents the treatment. Accordingly, the simulated physiological parameter can be replaced, in real-time, with an artifacted physiological parameter that includes the treatment artifact. In some examples, these issues can be addressed by including a detection region 116 on the housing 108 of the training apparatus 102. The detection region 116, in various examples, is configured to transmit a physical signal that can be detected by the monitoring sensor 112. If the monitoring sensor 112 is not positioned correctly or securely connected to the detection region 116, the signal detected by the monitoring sensor 112 is, in some examples, lost or distorted. Accordingly, the user 104 can determine that the monitoring sensor 112 is not positioned properly. Furthermore, in various implementations, the monitoring sensor 112 may be a real-world sensor (e.g., a sensor used on real-world patients). The training apparatus 102, in some implementations, is compatible with real-world sensors and real-world medical devices (e.g., monitoring devices, treatment devices, etc.), as well as training sensors and medical devices (e.g., sensors and medical devices specifically used for training exercises). Accordingly, the training exercise can provide a more realistic opportunity for users to effectively prepare for real-world medical emergencies by using a high-fidelity training apparatus.

In various implementations, the training apparatus 102 is configured to represent a wide variety of patients. For example, the shape and physical properties (e.g., appearance, stiffness, size, etc.) of the training apparatus 102 are, in various cases, configured to represent a diverse range of patient characteristics (e.g., age, gender, ethnicity, height, weight, body composition, body measurements, impedance, physical disabilities, etc.). In some examples, the physical properties of the training apparatus 102 can be manipulated. For instance, the training apparatus 102 may be inflated or include an inflatable bladder. In some examples, the pressure of the inflatable bladder can be increased to represent an intrathoracic pressure of a geriatric individual. In some examples, the training apparatus 102 is compatible with multiple housings (e.g., of different sizes, shapes, physical appearances, impedances, etc.).

In particular implementations, the training apparatus 102 may include a training region, such as a suturing pad, a laparoscopic trainer, an open surgery simulator, a catheterization model, an intubation trainer, an ultrasound simulator, a wound care simulator, or the like. For instance, the training region may include silicon or rubber pads that simulate skin layers to facilitate suturing practice. In some examples, the user 104 can implant, at the training region, a training or a real-world implantable cardioverter defibrillator or another implantable device.

The treatment sensor 114, in some examples, is configured to detect a treatment administered to the training apparatus 102. For instance, the treatment sensor 114 is configured to detect a compressive force (e.g., a chest compression), an electrical shock, an assisted ventilation, or another medical treatment. In various cases, the treatment sensor 114 includes an accelerometer, a speedometer, a pressure sensor, a force sensor, a linear potentiometer, or another suitable sensor. The force sensor, in some instances, includes a strain gauge, a piezoelectric sensor, a capacitive force sensor, an optical force sensor, a hydraulic force sensor, a pneumatic force sensor, a resistive force sensor, or the like. In various cases, the treatment sensor 114 includes a linear potentiometer. The linear potentiometer may have a resolution that is in a range of 0.05 to 0.5 centimeters (cm). In various implementations, the treatment sensor 114 is configured to detect an electrical shock applied to the training apparatus 102. In some examples, the treatment sensor 114 includes a current sensor, a voltage sensor, a capacitive sensor, or the like. In some examples, the treatment sensor 114 may include a voltage threshold trigger (e.g., a Schmitt trigger). For instance, the treatment sensor 114 may be electrically connected to a surge protective device that is connected to the housing 108. The treatment sensor 114 may identify an electrical shock administered to the housing 108 and determine that the electrical shock applied to the housing 108 is above a threshold voltage. In some examples, the surge protective device is configured to absorb the electrical shock based on, for instance, the treatment sensor 114 identifying the electrical shock. In various implementations, the treatment sensor 114 is configured to detect assisted ventilation administered to the training apparatus 102. In some examples, the treatment sensor 114 includes a flow meter, or the like.

In some examples, the treatment sensor 114 is configured to detect a movement of the training apparatus 102. For instance, the treatment sensor 114 may include a motion sensor (e.g., an accelerometer, a gyroscope, or the like).

The treatment sensor 114 is, in various implementations, connected to an analyzer 118 that is configured to generate an artifacted physiological parameter. In some examples, the treatment sensor 114 provides, to a detection circuit 120 of the analyzer 118, a signal indicative of the treatment administered to the training apparatus 102 and/or of the movement of the training apparatus 102. The analyzer 118 is configured to determine a treatment artifact based on the signal indicative of the treatment and/or movement. In some examples, the analyzer 118 is configured to determine the treatment artifact based on one or more characteristics of the training apparatus 102 (e.g., whether the training apparatus 102 represents a child, an adult, a bariatric patient, or an elderly patient).

In some examples, the detection circuit 120 includes a variable resistor. The resistance of the variable resistor corresponds to the signal detected by the treatment sensor 114. For instance, the treatment sensor 114 may be a force sensor configured to detect a compressive force applied to the housing, and the resistance of the variable resistor may correspond to the compressive force. The output voltage of the variable resistor corresponds to the treatment artifact. In some examples, the variable resistor is connected to a linear potentiometer. For instance, the variable resistor may be attached to a gear mechanism to ratio down chest compression depth, resulting in a smaller stroke length on the potentiometer.

In some examples, the analyzer 118 is configured to determine additional metrics (e.g., other physiological parameters) associated with the training apparatus 102 based on the treatment and/or the movement. For instance, the analyzer 118 may determine an ECG artifact based on the chest compressions administered to the training apparatus 102. The analyzer 118 may further determine that the chest compressions are associated with increased blood pressure and increased end-tidal carbon dioxide (EtCO2).

In various implementations of the present disclosure, the analyzer 118 is configured to receive an indication, from the user 104, of a treatment administered to the training apparatus 102. For instance, based on receiving an indication from an input device 121, the analyzer 118 determines a treatment artifact corresponding to an electrical shock. In some examples, the input device 121 provides, to the analyzer 118, an indication of a chest compression frequency and depth. In various cases, the analyzer 118 determines a treatment artifact corresponding to the chest compression. The input device 121, in some examples, functions as an interface between the user 104 and the analyzer 118. The input device 121 is configured to receive an input from the user 104 and includes, for instance, at least one of a keypad, a cursor control, a touch-sensitive display, a voice input device (e.g., a microphone), a haptic feedback device (e.g., a gyroscope), a touch sensor, or any combination thereof.

In some examples, the analyzer 118 is configured to generate the simulated physiological parameter. For instance, the analyzer 118 may include a signal generator, a microcontroller, or the like. In various instances, the analyzer 118 generates an artifacted physiological parameter based on the simulated physiological parameter and the treatment artifact. The analyzer 118, in some cases, is configured to transmit or provide the simulated physiological parameter and/or the artifacted physiological parameter to an external device, such as the monitoring device 110. The analyzer 118, in various examples, is configured to transmit or provide the additional metrics to the external device. For instance, the analyzer 118 may be electrically connected to the monitoring device 110. In some examples, the analyzer is electrically connected to a transceiver configured to transmit signals to the monitoring device 110. In some implementations, the transceiver is configured to transmit signals to the monitoring device 110 in a wired fashion and/or wirelessly. For example, the communication network(s) includes one or more wireless networks that include a 3^{rd} Generation Partnership Project (3GPP) network, such as a long-term evolution (LTE) radio access network (RAN) (e.g., over one or more LTE bands), a new radio (NR) RAN (e.g., over one or more NR bands), or a combination thereof. In some instances, the communication signals are electromagnetic (EM) signals, radio waves, or the like. In some implementations, the transceiver is configured to communicate with external devices by transmitting and/or receiving signals wirelessly. The external devices, for example, includes at least one of a sensor (e.g., the treatment sensor 114, the monitoring sensor 112), a medical device (e.g., the treatment device 106, the monitoring device 110), a computing device, a mobile device, or a server. Examples of wireless networks include WI-FI®, cellular networks, wireless local area networks (WLANs), and BLUETOOTH®. In various examples, the transceiver includes a network interface card (NIC), a network adapter, a local area network (LAN) adapter, or a physical, virtual, or logical address to connect to the various external devices and/or systems. In various examples, the transceiver includes any sort of wireless transceivers capable of engaging in wireless communication (e.g., radio frequency (RF) communication). In some examples, the transceiver transmits radio waves to the monitoring device 110 via a cell tower. In some cases, the transceiver is connected to a wireless modem, such as a modem for engaging in WI-FI®, WIGIG®, WIMAX®, BLUETOOTH®, or infrared communication. In some examples, the transceiver is configured to transmit signals in a wired fashion, such as by using a cable that connects the transceiver to the monitoring device 110. The transceiver and the monitoring device 110, in some implementations, include ports configured to receive connectors attached to the cable. In various examples, the transceiver includes a NIC to transmit data over the cable. Examples of wired connections include USB, USB-C, mini-USB, micro-USB, serial ports, and custom cables, among other examples.

In some examples, the analyzer 118 is disposed within the housing 108 of the training apparatus 102. In various implementations, the analyzer 118 is removable, such that the analyzer 118 can be used with a different housing. In some examples, the analyzer 118 is part of a medical device (e.g., the monitoring device 110, the treatment sensor 114, or the like). The analyzer 118 may be implemented in hardware (e.g., one or more processors), software (e.g., instructions executed by the processor(s)), or a combination thereof.

In various cases, the detection circuit 120 of the analyzer 118 provides the simulated physiological parameter and/or the artifacted physiological parameter to a simulation circuit 122 of the analyzer 118. The simulation circuit 122, in some instances, is configured to output a physical signal at the detection region 116 of the housing 108. In various cases, the physical signal corresponds to the simulated physiological parameter or the artifacted physiological parameter. For instance, a shape of a time profile of the physical signal may be similar to a shape of a time profile of a physiological parameter (e.g., an ECG, a blood oxygen saturation, a blood pressure, a pulse rate, an airway parameter, etc.). In some examples, the physical signal includes a voltage, a current, an impedance, a light signal, an acoustic signal, a pressure, or another physical signal. The monitoring sensor 112, in various examples, is configured to detect the physical signal. For instance, the acoustic signal may be indicative of heart sounds or breathing sounds. The monitoring sensor 112 may include a microphone configured to detect the acoustic signal. In some implementations, the monitoring sensor 112 is a training sensor, as described above. For instance, the monitoring sensor 112 may have a physical appearance similar to that of an ECG electrode, but the monitoring sensor 112 may be configured to detect a light signal. In various instances, the monitoring sensor 112 is a sensor configured to detect a physiological parameter. For example, the monitoring sensor 112 may include one or more ECG electrodes configured to detect electrical signals generated by a heart. In the environment 100, the ECG electrodes may detect, at the detection region 116, electrical signals (e.g., the physical signal) outputted by the simulation circuit 122.

The housing 108, in various cases, includes the detection region 116. The detection region 116, in some examples, includes a material that is configured to transmit the physical signal. For instance, the detection region 116 may include a conductive material. The monitoring sensor 112, in some examples, detects a voltage (e.g., the physical signal) from the conductive material of the detection region 116. The detection region 116 may, in various cases, include a material with an electrical impedance less than 20 Ohms. In some examples, the detection region 116 includes a material with an electrical impedance less than 10 Ohms. In various cases, the detection region 116 includes a material with an electrical conductivity in a range of 10⁻⁶ to 10⁸ S/m at 20° C. In various instances, the detection region 116 includes a transparent material (e.g., acrylic, glass, polycarbonate, resin, polystyrene, etc.). The monitoring sensor 112 may detect photons from a light source (e.g., a light emitting diode (LED), a laser, etc.) through the transparent material of the detection region 116. In some cases, the light source is connected to or part of the simulation circuit 122. In some examples, the detection region 116 includes a material that is configured to transmit sound waves. For instance, the detection region 116 may include a material with an acoustic impedance in a range of 10 to 50 kg/m²s. In some examples, a fluid (e.g., a liquid or a gas) may be disposed in a system of tubes in the training apparatus 102. The system of tubes may be connected to a pump (e.g., a positive displacement pump, a vacuum pump, etc.), a compressor, or another mechanism configured to control fluid flow. The monitoring sensor 112 is, in various instances, configured to detect a fluid flow through the detection region 116. The fluid flow is, in some cases, indicative of a blood flow parameter (e.g., a circulatory system parameter) or an airway parameter (e.g., a respiratory system parameter). For instance, the monitoring sensor 112 may include an optical flow sensor, an ultrasonic flow meter, a Doppler flow meter, a photoplethysmography sensor, or the like.

In some examples, the housing 108 includes more than one detection region. Each detection region is, for instance, configured to output a different physical signal. In various cases, each detection region corresponds to a different physiological parameter. In some examples, more than one detection region is associated with a physiological parameter. For instance, the housing 108 may have a plurality of subregions regions configured to output physical signals corresponding to an ECG (e.g., a 3-lead ECG, a 5-lead ECG, a 12-lead ECG, etc.). In various implementations, the monitoring sensor 112 includes 10 electrodes configured to detect a 12-lead ECG, and the housing 108 includes 10 subregions corresponding to each of the 10 electrodes. In some examples, the more than one detection regions enables determination of a position of the treatment (e.g., a position of the chest compressions relative to the training apparatus 102).

In various cases, the analyzer 118 is configured to remove the treatment artifact from the artifacted physiological parameter. For instance, the analyzer 118 may be configured to filter the artifacted physiological parameter to remove the treatment artifact. In various cases, the analyzer 118 may filter a signal transmitted by the monitoring sensor 112. For example, the monitoring sensor 112 may detect the physical signal and transmit, to the analyzer 118, a signal corresponding to the physical signal.

In some examples, the analyzer 118 is configured to analyze the treatment administered to the training apparatus 102. For instance, the analyzer 118 may provide feedback about the treatment to the user 104. In various instances, the analyzer 118 determines that a parameter of the treatment (also referred to as a “treatment parameter”) is not appropriate to treat a condition indicated by the simulated physiological parameter. Treatment parameters of chest compressions include, for instance, a frequency, a depth, or a position. In some cases, treatment parameters of assisted ventilation include a respiratory rate, a tidal volume, an inspiratory time, an expiratory time, an inspiratory pressure, an expiratory pressure, or the like. Treatment parameters of an electrical shock (e.g., a defibrillation shock) include an energy level, a waveform shape, a shock duration, or the like. In some examples, the analyzer 118 determines whether the treatment is appropriate based on one or more characteristics of the training apparatus 102. For instance, a size and physical appearance of the training apparatus 102 may be indicative of a child, and the analyzer 118 may compare treatment parameters to established treatment standards for children.

In various implementations, the monitoring device 110 is configured to output a training scenario. For instance, the monitoring device 110 may output, such as by a visual display, an indication of a patient history or a scenario associated with the condition indicated by the simulated physiological parameter. For instance, the simulated physiological parameter may be indicative of sudden cardiac arrest. In some instances, the monitoring device 110 outputs an indication of a history of myocardial infarctions. In some instances, the monitoring device 110 outputs an indication of a history of opioid use. The analyzer 118 may analyze the treatment administered to the training apparatus 102 based on the particular patient history to determine whether the treatment is appropriate. In various cases, the analyzer 118 provides, to the monitoring device 110, the patient history or the scenario. Examples of the scenario include an incident (e.g., a car accident, an injury, a natural disaster, etc.), a location (e.g., a climate, an altitude, etc.), an availability of particular medical devices, a description of a scene, or the like. In some examples, the user 104 or a supervisor may select, via the input device 121, the patient history or scenario.

In some examples, the training apparatus 102 provides physical responses indicative of the condition associated with the simulated physiological parameter, the training scenario, or the treatment administered to the training apparatus 102. For instance, the analyzer 118 may be connected to a speaker. The analyzer 118 is, in various cases, configured to output, via the speaker, sounds (e.g., gasps, breathing sounds, groaning sounds, words, or the like) indicative of the condition associated with the simulated physiological parameter. In some examples, the analyzer 118 is configured to cause movement of the training apparatus 102, such as limb movement, finger movement, eye movement (e.g., opening and closing eyes, pupil movement), seizing, breathing movements, or the like. For instance, the analyzer 118 may determine that a treatment administered to the training apparatus 102 is appropriate to treat the condition associated with the simulated physiological parameter. Accordingly, the analyzer 118 may cause eye movement and limb movement of the training apparatus 102 to indicate successful treatment.

In some implementations, the analyzer 118 is configured to determine a treatment decision. For instance, the analyzer 118 may determine a treatment decision based on the simulated physiological parameter and/or a treatment decision based on the artifacted physiological parameter. The analyzer 118, in various instances, determines a treatment decision based on the signal detected by the monitoring sensor 112. For example, the simulation circuit 122 outputs, to the detection region 116, a physical signal indicative of the artifacted physiological parameter. The monitoring sensor 112, in some cases, detects the physical signal. In various instances, the analyzer 118 determines a treatment decision based on receiving, from the monitoring sensor 112, a signal indicative of the physical signal. In various cases, the analyzer 118 filters the signal to remove the treatment artifact. In some examples, the analyzer determines a treatment decision based on the filtered signal. For example, the analyzer 118 may determine that an artifacted ECG corresponds to a treatment decision of administering a defibrillation shock. The analyzer 118 may determine that the filtered signal corresponds to a treatment decision of not administering a defibrillation shock.

According to various implementations of the present disclosure, the user 104 is a trainee participating in a medical training exercise. In various cases, the user 104 positions the monitoring sensor 112 onto the detection region 116 of the housing 108 of the training apparatus 102. The monitoring sensor 112 is, in some examples, configured to detect, at the detection region 116, a simulated ECG. The simulated ECG is, for instance, output by the simulation circuit 122 of the analyzer 118. In various instances, the monitoring sensor 112 provides, to the monitoring device 110, a signal indicative of the simulated ECG. The monitoring device 110 may output, such as by a visual display, the signal indicative of the simulated ECG.

In some examples, the user 104 operates the treatment device 106 to administer chest compressions to the training apparatus 102. The user 104, for instance, observes that a simulated ECG displayed on the monitoring device 110 is indicative of cardiac arrest. Accordingly, the user 104 determines a frequency, a depth, and a position of the chest compressions administered to the training apparatus 102 by the treatment device 106.

The treatment sensor 114, in various cases, identifies the chest compressions administered to the training apparatus 102. In some examples, the treatment sensor 114, in some examples, provides the signal indicative of the chest compressions to the detection circuit 120 of the analyzer 118. The analyzer 118, in various instances, determines an ECG treatment artifact indicative of the chest compressions. In some examples, the analyzer 118 determines and outputs, to the simulation circuit 122, an artifacted ECG based on the simulated ECG and the ECG treatment artifact. In various cases, the simulation circuit 122 outputs the artifacted ECG to the detection region 116. Accordingly, the monitoring sensor 112 detects, for instance, the artifacted ECG, and the monitoring device 110 displayed the signal indicative of the artifacted ECG detected by the monitoring sensor 112.

The user 104, in various implementations, observes, from the monitoring device 110, the artifacted ECG. In various examples, the analyzer 118 is configured to remove a treatment artifact from a physiological parameter. Accordingly, the analyzer 118 may receive, from the input device 121, an indication to remove the ECG treatment artifact from the simulated ECG. In some cases, the analyzer 118 removes, for instance by filtering the simulated ECG, the ECG treatment artifact. The analyzer, in some examples, provides the filtered ECG to the monitoring device 110.

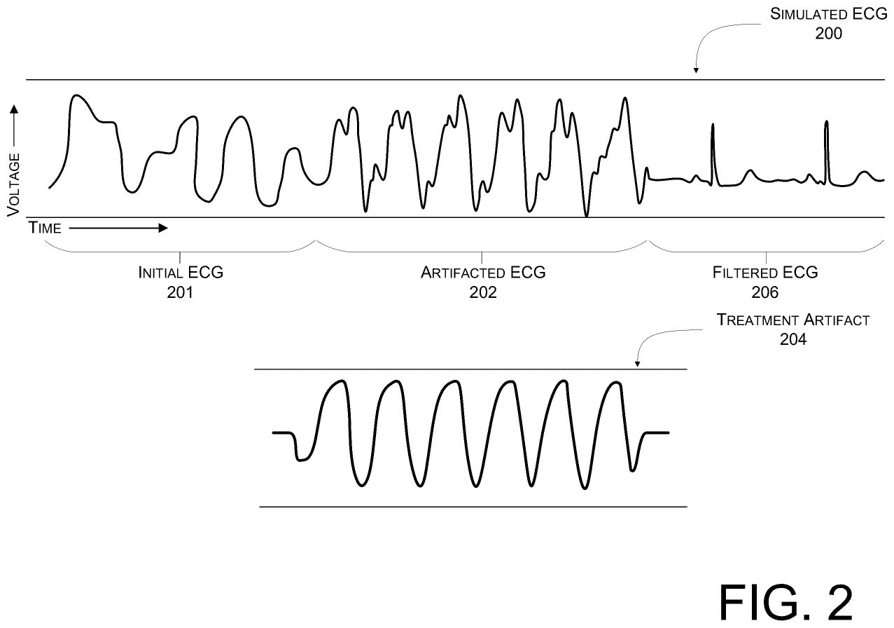

FIG. 2 illustrates an example simulated ECG 200 associated with a training apparatus. The training apparatus, in various examples, is the training apparatus 102 described with reference to FIG. 1. In some implementations, a monitoring device, such as the monitoring device 110 as described with reference to FIG. 1, displays the ECG traces depicted in FIG. 1. In some examples, the simulated ECG 200 depicted in FIG. 1 corresponds to a signal provided to the monitoring device by an analyzer, such as the analyzer 118 described with reference to FIG. 1. In other examples, the simulated ECG 200 depicted in FIG. 1 corresponds to a signal detected, from a housing (e.g., the housing 108) of the training apparatus, by a monitoring sensor (e.g., the monitoring sensor 112). In various cases, the monitoring sensor, for instance, transmits a signal indicative of the simulated ECG 200 to the monitoring device.

In some examples, an initial ECG 201 corresponds to the time period when a treatment is not being administered to the training apparatus. For instance, the initial ECG 201 may be displayed by the monitoring device when a user (e.g., the user 104) positions the monitoring sensor on the housing. In various cases, the initial ECG 201 is synthetically generated by the analyzer. In some examples, the initial ECG 201 is recorded from a real-world patient and provided to the analyzer. The initial ECG 201, in some examples, corresponds to an ECG of a real-world patient in cardiac arrest. For instance, the initial ECG 201 may correspond to an ECG of a real-world patient with ventricular fibrillation.

In various cases, an artifacted ECG 202 includes a treatment artifact 204 corresponding to chest compressions administered to the training apparatus. In some instances, the chest compressions are administered, by a user (e.g., the user 104), to the training apparatus. A treatment sensor (e.g., the treatment sensor 114) detects the chest compressions and provides, to the analyzer, a signal indicative of the chest compressions. In other instances, a mechanical chest compression device (e.g., the treatment device 106) administers the chest compressions to the training apparatus. The mechanical chest compression device, for instance, is configured to provide, to the analyzer, the treatment signal indicative of the chest compressions. In some examples, the analyzer determines, based on the signal indicative of the chest compressions, the treatment artifact 204. In various cases, the analyzer determines the treatment artifact 204 based on a signal transmitted by an input device (e.g., the input device 121). In some examples, the user provides, via an input device, an indication of chest compression parameters (e.g., a frequency, a depth, a start time, etc.) to the analyzer. The analyzer determines the artifacted ECG 202 based on the ECG 200 and the treatment artifact 204.

In some implementations, a computing device (e.g., the analyzer, the monitoring device, or an external computing device) is configured to remove the treatment artifact 204 from the artifacted ECG 202. The computing device generates a filtered ECG 206 by removing (e.g., by filtering) the artifacted ECG 202. In various cases, the computing device provides, to the monitoring device and/or the analyzer, the filtered ECG 206. According to various implementations, the treatment decision depends on whether it is based on the artifacted ECG 202 or the filtered ECG 206. For instance, the user or the computing device may determine, based on analyzing the artifacted ECG 202, that a shockable rhythm cannot be identified. Accordingly, the user or the computing device refrains from administering the defibrillation shock. The user or the computing device determines, based on analyzing the filtered ECG 206, that a shockable rhythm is present, in various cases. The user or the computing device may cause a defibrillation shock to be administered.

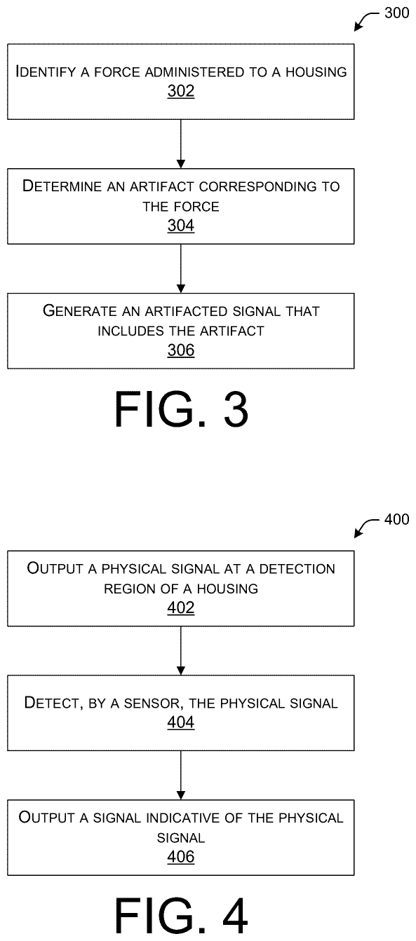

FIG. 3 illustrates an example process 300 for generating an artifacted signal based on a force administered to a training apparatus (e.g., the training apparatus 102). According to some implementations, the process 300 is performed by an entity, such as a computing device (e.g., the analyzer 118), sensor (e.g., the monitoring sensor 112, the treatment sensor 114), medical device (e.g., the treatment device 106, the monitoring device 110), at least one processor, or a combination thereof.

At 302, the entity identifies the force administered to a housing (e.g., the housing 108) of the training apparatus. The housing, in various examples, is configured to withstand the force. The force, in some cases, is a compressive force administered by a user (e.g., the user 104) or by a treatment device (e.g., the treatment device 106). In various instances, the entity detects the force and determines a parameter of the force (e.g., a frequency, a time duration, a magnitude, a release time duration, etc.). In some examples, the release time duration refers to the time duration from the maximum force to the removal of the force. In some examples, the release time duration refers to the duration for the training apparatus to return to its original state (e.g., the physical state before force administration) after the force is removed. In particular implementations, the entity includes a linear potentiometer configured to determine a linear displacement corresponding to, for instance, the compressive force. The output voltage of the linear potentiometer is, in various cases, indicative of the linear displacement. In some examples, the entity is configured to detect a frequency and/or a magnitude of the force based on the output voltage of the linear potentiometer.

While FIG. 3 describes the entity identifying a force administered to the housing, implementations of the present disclosure are not so limited. In various implementations, the entity identifies another treatment administered to a training apparatus. For instance, the entity may identify assisted ventilation, an electrical shock, or another treatment administered to the training apparatus.

At 304, the entity determines an artifact corresponding to the force. For instance, based on analyzing the force administered to the housing, the entity may determine a magnitude, a shape, a frequency, or another parameter of the artifact. In some examples, the entity identifies a simulated physiological parameter associated with the training apparatus. The entity determines the artifact based on the simulated physiological parameter. For instance, an artifact generated for a simulated ECG may be different than an artifact generated for a simulated blood oxygen saturation.

At 306, the entity generates an artifacted signal that includes the artifact. In some examples, the entity adds the artifact to the simulated physiological parameter. For instance, the entity may include or be connected to a variable resistor. The resistance of the variable resistor corresponds to the force administered to the housing. In some examples, the output voltage of the variable resistor is added to a voltage signal of a simulated physiological parameter (e.g., a simulated ECG) to generate the artifacted physiological parameter (e.g., the artifacted ECG).

In various examples, the entity outputs, or causes an output device to output, the artifacted signal. In some cases, the entity is configured to remove the artifact from the artifacted signal. For instance, the entity may be configured to determine a treatment decision corresponding to the simulated physiological parameter. The entity, in some cases, determines a first treatment decision based on the artifacted signal. In various instances, the entity receives, from an input device, an indication from a user. Based on receiving the indication, the entity generates a filtered physiological parameter by removing the artifact from the artifacted signal. The entity, for example, determines a second treatment decision based on the filtered physiological parameter.

In some instances, the entity is configured to receive, from the input device, an indication of a treatment. For instance, a user determines, based on the first and/or the second treatment decision, to administer a treatment (such as a defibrillation shock) to the training apparatus. For example, the user and/or the entity may identify a shockable arrhythmia in the artifacted physiological parameter and/or the filtered physiological parameter. In some examples, the treatment includes a defibrillation shock, and the entity outputs an indication to stand clear of the training apparatus, for instance, in preparation of the defibrillation shock. In some instances, the entity administers, or causes a treatment device to administer, the defibrillation shock to the training apparatus. The treatment device, in various cases, is a real-world treatment device or a training treatment device. Based on receiving the indication from the user, the entity generates a second artifact corresponding to the treatment. In various implementations, the entity replaces the artifacted signal with an artifacted signal that includes the second artifact. In some examples, the entity causes the output device to output the artifacted signal that includes the second artifact.

FIG. 4 illustrates an example process 400 for outputting, to a housing (e.g., the housing 108), a physical signal corresponding to a simulated physiological signal. According to some implementations, the process 400 is performed by an entity, such as a computing device (e.g., the analyzer 118), sensor (e.g., the monitoring sensor 112, the treatment sensor 114), medical device (e.g., the treatment device 106, the monitoring device 110), at least one processor, or a combination thereof.

At 402, the entity outputs the physical signal at the housing. In some examples, the entity outputs the physical signal at a region (e.g., the detection region 116) of the housing. In various implementations, the housing is configured to receive a compressive force. The physical signal is, for example, indicative of a simulated physiological parameter (e.g., the simulated physiological parameter described with reference to FIG. 1) or an artifacted physiological parameter (e.g., the artifacted physiological parameter described with reference to FIG. 1). In various examples, the entity determines the artifacted physiological parameter based on the simulated physiological parameter and an artifact. The artifact, in some cases, corresponds to a treatment (e.g., chest compressions, an electrical shock, assisted ventilation, or the like) administered to the housing. In various implementations, the entity determines the artifact based on receiving, from a sensor or an input device, a signal indicative of the treatment administered to the housing.

At 404, the entity detects the physical signal from the region of the housing. The region is, for instance, configured to output the physical signal. For example, the region includes a conductive material configured to output a voltage. In some examples, the entity detects physical signals from multiple regions of the housing. For example, the entity may output, to six regions of the housing, six physical signals corresponding to a 6-lead ECG. Based on detecting the six physical signals, the entity analyzes the six physical signal to determine the 6-lead ECG.

At 406, the entity outputs a signal indicative of the physical signal. In various cases, the entity outputs to signal to a visual display, an audio speaker, an external device (e.g., the monitoring device 110 or a user device), or the like. In some examples, the entity filters the physical signal. For instance, the entity identifies, in the physical signal, an artifact corresponding to a treatment administered to the housing. In some examples, the entity generates a filtered signal by removing the artifact from the physical signal. In various instances, the entity outputs the signal indicative of the physical signal and/or the filtered signal.

In some implementations, the entity is configured to determine a follow-up treatment decision based on detecting the physical signal. In various cases, the entity determines the follow-up treatment decision based on the filtered signal. In some instances, the entity includes or is connected to a treatment device configured to administer a follow-up treatment to the training apparatus (e.g., a mechanical chest compression device, a defibrillator, a ventilator, or the like). In various cases, the entity outputs, to the treatment device, an indication to administer the follow-up treatment based on analyzing the filtered signal. In some examples, the entity outputs, to the external device, an indication that the follow-up treatment decision cannot be determined due to the presence of an artifact in the detected physical signal.

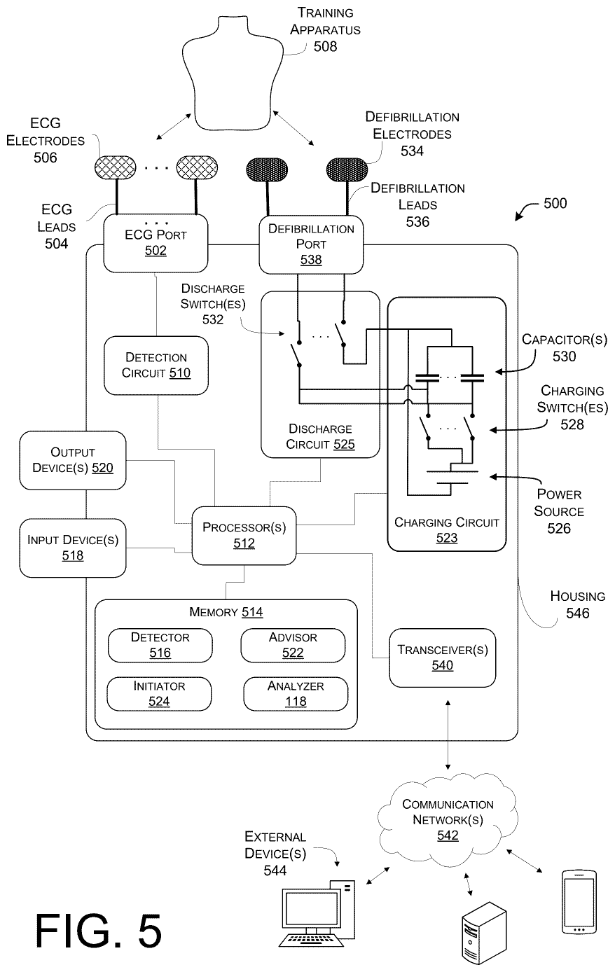

FIG. 5 illustrates an example of an external defibrillator 500 configured to perform various functions described herein. For example, the external defibrillator 500 is the monitoring device 110 described above with reference to FIG. 1. In some examples, the external defibrillator 500 includes the analyzer 118 described above with reference to FIG. 1.

The external defibrillator 500 includes an electrocardiogram (ECG) port 502 connected to multiple ECG leads 504. In some cases, the ECG leads 504 are removeable from the ECG port 502. For instance, the ECG leads 504 are plugged into the ECG port 502. The ECG leads 504 are connected to ECG electrodes 506, respectively. In various implementations, the ECG electrodes 506 are disposed on different locations on a training apparatus 508 (e.g., the training apparatus 102). A detection circuit 510 is configured to detect relative voltages between the ECG electrodes 506. These voltages are indicative of the electrical activity of the heart of the training apparatus 508.

In various implementations, the ECG electrodes 506 are in contact with the different locations on the housing (e.g., the housing 108) of the training apparatus 508. In some examples, a first one of the ECG electrodes 506 is placed on a first region (e.g., the detection region 116) of the training apparatus 508, a second one of the ECG electrodes 506 is placed on a second region of the training apparatus 508, and a third one of the ECG electrodes 506 is placed on a third region of the training apparatus 508. In various implementations, a first physical signal (e.g., the physical signal described with reference to FIG. 1) is detected by the first ECG electrode, a second physical signal is detected by the second ECG electrode, and a third physical signal is detected by the third ECG electrode. The first, second, and third physical signals, in some examples, correspond to a simulated ECG (e.g., the simulated physiological parameter described with reference to FIG. 1) or an artifacted ECG (e.g., the artifacted physiological parameter described with reference to FIG. 1). In some examples, the training apparatus 508 includes a shape of a human body. In various instances, the first region corresponds to a position between the heart and the right arm of the human body, the second region corresponds to a position between the heart and the left arm of the human body, and the third region corresponds to a position between the heart and a leg (either the left leg or the right leg) of the human body.

In these examples, the detection circuit 510 is configured to measure the relative voltages between the first, second, and third ECG electrodes 506. Respective pairings of the ECG electrodes 506 are referred to as “leads,” and the voltages between the pairs of ECG electrodes 506 are known as “lead voltages.” In some examples, more than three ECG electrodes 506 are included, such that 5-lead or 12-lead ECG signals are detected by the detection circuit 510.

The detection circuit 510 includes at least one analog circuit, at least one digital circuit, or a combination thereof. The detection circuit 510 receives the analog electrical signals from the ECG electrodes 506, via the ECG port 502 and the ECG leads 504. In some cases, the detection circuit 510 includes one or more analog filters configured to filter noise and/or artifact from the electrical signals. The detection circuit 510 includes an analog-to-digital (ADC) in various examples. The detection circuit 510 generates a digital signal indicative of the analog electrical signals from the ECG electrodes 506 (e.g., the signal indicative of the physical signal described with reference to FIG. 1). This digital signal can be referred to as an “ECG signal” or an “ECG.”

In some cases, the detection circuit 510 further detects an electrical impedance between at least one pair of the ECG electrodes 506. For example, the detection circuit 510 includes, or otherwise controls, a power source that applies a known voltage (or current) across a pair of the ECG electrodes 506 and detects a resultant current (or voltage) between the pair of the ECG electrodes 506. The impedance is generated based on the applied signal (voltage or current) and the resultant signal (current or voltage). In various cases, the impedance corresponds to chest compressions performed on the training apparatus 508, artificial respiration administered to the training apparatus 508, and other physiological states of the training apparatus 508. In various examples, the detection circuit 510 includes one or more analog filters configured to filter noise and/or artifact from the resultant signal. The detection circuit 510 generates a digital signal indicative of the impedance using an ADC. This digital signal can be referred to as an “impedance signal” or an “impedance.”

The detection circuit 510 provides the ECG signal and/or the impedance signal one or more processors 512 in the external defibrillator 500. In some implementations, the processor(s) 512 includes a central processing unit (CPU), a graphics processing unit (GPU), both CPU and GPU, or other processing unit or component known in the art. The processor(s) 512 may perform any of the functions described in relation to the analyzer 118. For instance, the processor(s) 512 may determine, based on identifying a force administered to the training apparatus 508, an artifact corresponding to a simulated physiological parameter.

The processor(s) 512 is operably connected to memory 514. In various implementations, the memory 514 is volatile (such as random access memory (RAM)), non-volatile (such as read only memory (ROM), flash memory, etc.) or some combination of the two. The memory 514 stores instructions that, when executed by the processor(s) 512, causes the processor(s) 512 to perform various operations. In various examples, the memory 514 stores methods, threads, processes, applications, objects, modules, any other sort of executable instruction, or a combination thereof. In some cases, the memory 514 stores files, databases, or a combination thereof. In some examples, the memory 514 includes, but is not limited to, RAM, ROM, electrically erasable programmable read-only memory (EEPROM), flash memory, or any other memory technology. In some examples, the memory 514 includes one or more of CD-ROMs, digital versatile discs (DVDs), content-addressable memory (CAM), or other optical storage, magnetic cassettes, magnetic tape, magnetic disk storage or other magnetic storage devices, or any other medium which can be used to store the desired information and which can be accessed by the processor(s) 512 and/or the external defibrillator 500. In some cases, the memory 514 at least temporarily stores the ECG signal and/or the impedance signal.

In some examples, the memory 514 includes the analyzer 118. The analyzer 118 may cause the processor(s) 512 to perform various functions described above with reference to FIG. 1. For instance, the analyzer 118 may cause the processor(s) 512 to generated an artifacted physiological parameter based on a simulated physiological parameter and an artifact corresponding to a treatment administered to the training apparatus 508. The analyzer 118 may cause the processor(s) 512 to determine a treatment decision based on the simulated physiological parameter and/or the artifacted physiological parameter. The analyzer 118 may cause the processor(s) 512 to determine a treatment decision based on a physical signal detected from the training apparatus 508.

In various examples, the memory 514 includes a detector 516, which causes the processor(s) 512 to determine whether the ECG signal and/or the impedance signal correspond to a particular heart rhythm. For instance, the processor(s) 512 determines whether the ECG signal and/or the impedance signal correspond to a shockable rhythm that is treatable by defibrillation. Examples of shockable rhythms include ventricular fibrillation (VF) and ventricular tachycardia (V-Tach). In some examples, the processor(s) 512 determines whether any of a variety of different rhythms (e.g., asystole, sinus rhythm, atrial fibrillation (AF), etc.) are present in the ECG signal.

The processor(s) 512 is operably connected to one or more input devices 518 (e.g., the input device 121) and one or more output devices 520. Collectively, the input device(s) 518 and the output device(s) 520 function as an interface between a user and the defibrillator 500. The input device(s) 518 is configured to receive an input from a user (e.g., the user 104) and includes at least one of a keypad, a cursor control, a touch-sensitive display, a voice input device (e.g., a microphone), a haptic feedback device (e.g., a gyroscope), or any combination thereof. The output device(s) 520 includes at least one of a display, a speaker, a haptic output device, a printer, or any combination thereof. In various examples, the processor(s) 512 causes a display among the input device(s) 518 to visually output a waveform of the ECG signal and/or the impedance signal. In some examples, the analyzer 118 may cause the processor(s) 512 to provide, or cause the output device(s) 520 to provide, a visual indication of a treatment decision based on the ECG signal. In some implementations, the input device(s) 518 includes one or more touch sensors, the output device(s) 520 includes a display screen, and the touch sensor(s) are integrated with the display screen. Thus, in some cases, the external defibrillator 500 includes a touchscreen configured to receive user input signal(s) and visually output physiological parameters, such as the ECG signal and/or the impedance signal.

In some examples, the memory 514 includes an advisor 522, which, when executed by the processor(s) 512, causes the processor(s) 512 to generate advice and/or control the output device(s) 520 to output the advice to a user (e.g., a rescuer). In some examples, the processor(s) 512 provides, or causes the output device(s) 520 to provide, an instruction to perform CPR on the training apparatus 508. In some cases, the processor(s) 512 evaluates, based on the ECG signal, the impedance signal, or other physiological parameters, CPR being performed on the training apparatus 508 and causes the output device(s) 520 to provide feedback about the CPR in the instruction. According to some examples, the processor(s) 512, upon identifying that a shockable rhythm is present in the ECG signal, causes the output device(s) 520 to output an instruction and/or recommendation to administer a defibrillation shock to the training apparatus 508.

The memory 514 also includes an initiator 524 which, when executed by the processor(s) 512, causes the processor(s) 512 to control other elements of the external defibrillator 500 in order to administer a defibrillation shock to the training apparatus 508. In some examples, the processor(s) 512 executing the initiator 524 selectively causes the administration of the defibrillation shock based on determining that ECG signal and/or the impedance signal correspond to the shockable rhythm and/or based on an input from a user (received, e.g., by the input device(s) 518. In some cases, the processor(s) 512 causes the defibrillation shock to be output at a particular time, which is determined by the processor(s) 512 based on the ECG signal and/or the impedance signal. In some implementations, the external defibrillator 500 is a training defibrillator that is configured to output a defibrillation shock with less energy than a defibrillation shock administered to treat a human subject. In some examples, the external defibrillator 500 may not output a shock in response to the processor(s) 512 executing the initiator 524. In various cases, the external defibrillator 500 may output, to an external device (e.g., the analyzer 118), an indication that a defibrillation shock was administered to the training apparatus.

The processor(s) 512 is operably connected to a charging circuit 523 and a discharge circuit 525. In various implementations, the charging circuit 523 includes a power source 526, one or more charging switches 528, and one or more capacitors 530. The power source 526 includes, for instance, a battery. The processor(s) 512 initiates a defibrillation shock by causing the power source 526 to charge at least one capacitor among the capacitor(s) 530. For example, the processor(s) 512 activates at least one of the charging switch(es) 528 in the charging circuit 523 to complete a first circuit connecting the power source 526 and the capacitor to be charged. Then, the processor(s) 512 causes the discharge circuit 525 to discharge energy stored in the charged capacitor across a pair of defibrillation electrodes 534, which are in contact with the training apparatus 508. For example, the processor(s) 512 deactivates the charging switch(es) 528 completing the first circuit between the capacitor(s) 530 and the power source 526, and activates one or more discharge switches 532 completing a second circuit connecting the charged capacitor 530 and at least a portion of the training apparatus 508 disposed between defibrillation electrodes 534.

The energy is discharged from the defibrillation electrodes 534 in the form of a defibrillation shock. For example, the defibrillation electrodes 534 are connected to the housing of the training apparatus 508 and located at positions that correspond to different sides of the heart of the training apparatus 508, such that the defibrillation shock is applied across a position that corresponds to the heart of the training apparatus 508. In some examples, the defibrillation electrodes 534 are located at positions that correspond to the anterior side of the training apparatus 508 and/or at positions that correspond to the posterior side of the training apparatus 508. The defibrillation shock, in various examples, is configured to depolarize a significant number of heart cells of a human subject in a short amount of time. The defibrillation shock, for example, is configured to interrupt the propagation of the shockable rhythm (e.g., VF or V-Tach) through the heart of the human subject. In some examples, the defibrillation shock is 360 J or lower with a duration of 0.015 seconds. In some examples, the defibrillation shock is between 50 J and 360 J. In some examples, the defibrillation shock has a duration between 0.005 to 0.05 seconds. For instance, the duration of the defibrillation shock may be determined based on an electrical impedance of the training apparatus 508. In some cases, the defibrillation shock has a multiphasic (e.g., biphasic) waveform. The discharge switch(es) 532 are controlled by the processor(s) 512, for example. In various implementations, the defibrillation electrodes 534 are connected to defibrillation leads 536. The defibrillation leads 536 are connected to a defibrillation port 538, in implementations. According to various examples, the defibrillation leads 536 are removable from the defibrillation port 538. For example, the defibrillation leads 536 are plugged into the defibrillation port 538.

In various examples, a second pair of defibrillation electrodes may be in contact with the training apparatus 509. For instance, the processor(s) 512 is operably connected to a second charging circuit and a second discharge circuit. The processor(s) 512 is, in some cases, configured to cause a defibrillation shock to be discharged from the second pair of defibrillation electrodes in a similar manner to the defibrillation shock discharge from the defibrillation electrodes 534. In some examples, the second pair of electrodes can facilitate the administration of double sequential defibrillation (DSD) treatment to the training apparatus 508. In various implementations, the processor(s) 512 is configured to cause the defibrillation electrodes 534 and the second pair of defibrillation electrodes to output defibrillation shocks simultaneously or in rapid succession. Accordingly, energy levels up to 720 J may be outputted to the training apparatus 508, for instance, during administration of DSD treatment. In some instances, the processor(s) 512 is configured to modify the administration of DSD treatment by, for instance, altering the coupling (e.g., timing) between the shocks, changing the polarity of one or more of the shocks, changing one or more waveform characteristics of one or more of the shocks, and/or changing an energy level of one or more of the shocks.

In various implementations, the processor(s) 512 is operably connected to one or more transceivers 540 that transmit and/or receive data over one or more communication networks 542. For example, the transceiver(s) 540 includes a NIC, a network adapter, a LAN adapter, or a physical, virtual, or logical address to connect to the various external devices and/or systems. In various examples, the transceiver(s) 540 includes any sort of wireless transceivers capable of engaging in wireless communication (e.g., RF communication). For example, the communication network(s) 542 includes one or more wireless networks that include a 3GPP network, such as a LTE RAN (e.g., over one or more LTE bands), a NR RAN (e.g., over one or more NR bands), or a combination thereof. In some cases, the transceiver(s) 540 includes other wireless modems, such as a modem for engaging in WI-FI®, WIGIG®, WIMAX®, BLUETOOTH®, or infrared communication over the communication network(s) 542.

The defibrillator 500 is configured to transmit and/or receive data (e.g., ECG data, impedance data, data indicative of one or more detected heart rhythms of the training apparatus 508, data indicative of one or more defibrillation shocks administered to the training apparatus 508, etc.) with one or more external devices 544 (e.g., the treatment device 106, the analyzer 118, the monitoring sensor 112, the treatment sensor 114, etc.) via the communication network(s) 542. The external devices 544 include, for instance, mobile devices (e.g., mobile phones, smart watches, etc.), Internet of Things (IOT) devices, medical devices, computers (e.g., laptop devices, servers, etc.), or any other type of computing device configured to communicate over the communication network(s) 542. In some examples, the external device(s) 544 is located remotely from the defibrillator 500, such as at a remote clinical environment (e.g., a hospital). According to various implementations, the processor(s) 412 causes the transceiver(s) 540 to transmit data to the external device(s) 544. In some cases, the transceiver(s) 540 receives data from the external device(s) 544 and the transceiver(s) 540 provide the received data to the processor(s) 512 for further analysis.

In various implementations, the external defibrillator 500 also includes a housing 546 that at least partially encloses other elements of the external defibrillator 500. For example, the housing 546 encloses the detection circuit 510, the processor(s) 512, the memory 514, the charging circuit 523, the transceiver(s) 540, or any combination thereof. In some cases, the input device(s) 518 and output device(s) 520 extend from an interior space at least partially surrounded by the housing 546 through a wall of the housing 546. In various examples, the housing 546 acts as a barrier to moisture, electrical interference, and/or dust, thereby protecting various components in the external defibrillator 500 from damage.

In some implementations, the external defibrillator 500 is an automated external defibrillator (AED) operated by an untrained user (e.g., the user 104, a bystander, layperson, etc.) and can be operated in an automatic mode. In automatic mode, the processor(s) 512 automatically identifies a rhythm in the ECG signal, makes a decision whether to administer a defibrillation shock, charges the capacitor(s) 530, discharges the capacitor(s) 530, or any combination thereof. In some cases, the processor(s) 512 controls the output device(s) 520 to output (e.g., display) a simplified user interface to the untrained user. For example, the processor(s) 512 refrains from causing the output device(s) 520 to display a waveform of the ECG signal and/or the impedance signal to the untrained user, in order to simplify operation of the external defibrillator 500.

In some examples, the external defibrillator 500 is a monitor-defibrillator utilized by a trained user (e.g., the user 104, a clinician, an emergency responder, etc.) and can be operated in a manual mode or the automatic mode. When the external defibrillator 500 operates in manual mode, the processor(s) 512 cause the output device(s) 520 to display a variety of information that may be relevant to the trained user, such as waveforms indicating the ECG data and/or impedance data, notifications about detected heart rhythms, and the like.

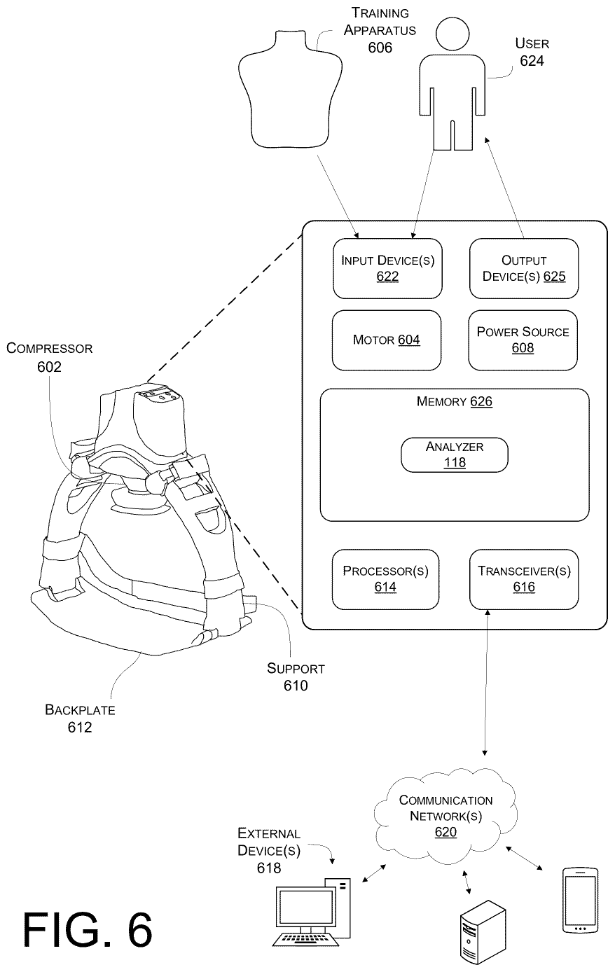

FIG. 6 illustrates a chest compression device 600 configured to perform various functions described herein. For example, the chest compression device 600 is the treatment device 106 described in FIG. 1. In some examples, the chest compression device 600 includes the analyzer 118 described above with reference to FIG. 1.

In various implementations, the chest compression device 600 includes a compressor 602 that is operatively coupled to a motor 604. The compressor 602 physically administers a force to a training apparatus 606. In some examples, the training apparatus 606 includes a shape of a torso of a human body, and the compressor 602 physically administers a force to a position that corresponds to the chest of the human body. The compressor 602 may be configured to compress the chest of a human subject. In some examples, the compressor 602 includes at least one piston that periodically moves between two positions (e.g., a compressed position and a release position) at a compression frequency. For example, when the piston is positioned on the training apparatus 606, the piston compresses the training apparatus 606 when the piston is moved into the compressed position. A suction cup may be positioned on a tip of the piston, such that the suction cup contacts the training apparatus 606 during operation. In various cases, the compressor 602 includes a band that periodically tightens to a first tension and loosens to a second tension at a compression frequency. For instance, when the band is disposed around the training apparatus 606, the band compresses the training apparatus 606 when the band tightens.

The motor 604 is configured to convert electrical energy stored in a power source 608 into mechanical energy that moves and/or tightens the compressor 602, thereby causing the compressor 602 to administer the force to the training apparatus 606. In various implementations, the power source 608 is portable. For instance, the power source 608 includes at least one rechargeable (e.g., lithium-ion) battery. In some cases, the power source 608 supplies electrical energy to one or more elements of the chest compression device 600 described herein.

In various cases, the chest compression device 600 includes a support 610 that is physically coupled to the compressor 602, such that the compressor 602 maintains a position relative to the training apparatus 606 during operation. In some implementations, the support 610 is physically coupled to a backplate 612, cot, or other external structure with a fixed position relative to the training apparatus 606. According to some cases, the support 610 is physically coupled to a portion of the training apparatus 606, such as wrists of the training apparatus 606.

The operation of the chest compression device 600 may be controlled by at least one processor 614. The processor 614 may perform any of the functions described in relation to the analyzer 118. In various implementations, the motor 604 is communicatively coupled to the processor(s) 614. Specifically, the processor(s) 614 is configured to output a control signal to the motor 604 that causes the motor 604 to actuate the compressor 602. For instance, the motor 604 causes the compressor 602 to administer the compressions to the training apparatus 606 based on the control signal. In some cases, the control signal indicates one or more treatment parameters of the compressions. Examples of treatment parameters include a frequency, timing, depth, force, position, velocity, and acceleration of the compressor 602 administering the compressions. According to various cases, the control signal causes the motor 604 to cease compressions.

In various implementations, the chest compression device 600 includes at least one transceiver 616 configured to communicate with at least one external device 618 (e.g., the input device 121, the analyzer 118, the monitoring device 110) over one or more communication networks 620. Any communication network described herein can be included in the communication network(s) 542 illustrated in FIG. 5. The external device(s) 618, for example, includes at least one of a monitor-defibrillator, an AED, an ECMO device, a ventilation device, a patient monitor, a mobile phone, a server, or a computing device. In some implementations, the transceiver(s) 616 is configured to communicate with the external device(s) 618 by transmitting and/or receiving signals wirelessly. For example, the transceiver(s) 616 includes a NIC, a network adapter, a LAN adapter, or a physical, virtual, or logical address to connect to the various external devices and/or systems. In various examples, the transceiver(s) 616 includes any sort of wireless transceivers capable of engaging in wireless communication (e.g., RF communication). For example, the communication network(s) 620 includes one or more wireless networks that include a 3GPP network, such as an LTE RAN (e.g., over one or more LTE bands), an NR RAN (e.g., over one or more NR bands), or a combination thereof. In some cases, the transceiver(s) 616 includes other wireless modems, such as a modem for engaging in WI-FI®, WIGIG®, WIMAX®, BLUETOOTH®, or infrared communication over the communication network(s) 620. The signals, in various cases, encode data in the form of data packets, datagrams, or the like. In some cases, the signals are transmitted as compressions are being administered by the chest compression device 600 (e.g., for real-time feedback by the external device(s) 618), after compressions are administered by the chest compression device 600 (e.g., for post-event review at the external device 618), or a combination thereof.

In various cases, the processor(s) 614 generates the control signal based on data encoded in the signals received from the external device(s) 618. For instance, the signals include an instruction to initiate the compressions, and the processor(s) 614 instructs the motor 604 to begin actuating the compressor 602 in accordance with the signals.

In some cases, the chest compression device 600 includes at least one input device 622. In various examples, the input device(s) 622 is configured to receive an input signal from a user 624 (e.g., the user 104), who may be a trainee interacting with the training apparatus 606. Examples of the input device(s) 622 include, for instance, at a keypad, a cursor control, a touch-sensitive display, a voice input device (e.g., a microphone), a haptic feedback device (e.g., a gyroscope), or any combination thereof. In various implementations, the processor(s) 614 generate the control signal based on the input signal. For instance, the processor(s) 614 generate the control signal to adjust a frequency of the compressions based on the chest compression device 600 detecting a selection by the user 624 of a user interface element displayed on a touchscreen or detecting the user 624 pressing a button integrated with an external housing of the chest compression device 600.

According to some examples, the input device(s) 622 include one or more sensors (e.g., the treatment sensor 114, the monitoring sensor 112). The sensor(s), for example, is configured to detect a physiological parameter of the training apparatus 606. In some implementations, the sensor(s) is configured to detect a state parameter of the chest compression device 600, such as a position of the compressor 602 with respect to the training apparatus 606 or the backplate 612, a force administered by the compressor 602 on the training apparatus 606, a force administered onto the backplate 612 by the body of the training apparatus 606 during a compression, or the like. According to some implementations, the signals transmitted by the transceiver(s) 616 indicate the physiological parameter(s) and/or the state parameter(s).

The chest compression device 600 further includes at least one output device 625, in various implementations. Examples of the output device(s) 625 include, for instance, least one of a display (e.g., a projector, an LED screen, etc.), a speaker, a haptic output device, a printer, or any combination thereof. In some implementations, the output device(s) 625 include a screen configured to display various parameters detected by and/or reported to the chest compression device 600, a charge level of the power source 608, a timer indicating a time since compressions were initiated or paused, and other relevant information.

The chest compression device 600 further includes memory 626. In various implementations, the memory 626 is volatile (such as random access memory (RAM)), non-volatile (such as read only memory (ROM), flash memory, etc.) or some combination of the two. The memory 626 stores instructions that, when executed by the processor(s) 614, causes the processor(s) 614 to perform various operations. In various examples, the memory 626 stores methods, threads, processes, applications, objects, modules, any other sort of executable instruction, or a combination thereof. In some cases, the memory 626 stores files, databases, or a combination thereof. In some examples, the memory 626 includes, but is not limited to, RAM, ROM, EEPROM, flash memory, or any other memory technology. In some examples, the memory 626 includes one or more of CD-ROMs, DVDs, CAM, or other optical storage, magnetic cassettes, magnetic tape, magnetic disk storage or other magnetic storage devices, or any other medium which can be used to store the desired information. In various cases, the memory 626 stores instructions, programs, threads, objects, data, or any combination thereof, that cause the processor(s) 614 to perform various functions. In various cases, the memory 626 stores one or more parameters that are detected by the chest compression device 600 and/or reported to the chest compression device 600.

In implementations of the present disclosure, the memory 626 includes the analyzer 118. The analyzer 118 may cause the processor(s) 614 to perform various functions described above with reference to FIG. 1. For instance, the analyzer 118 may cause the processor(s) 614 to identify a treatment (e.g., a force) administered to the training apparatus 606. The analyzer 118 may cause the processor(s) 614 to generate an artifacted physiological parameter based on a simulated physiological parameter and an artifact corresponding to the treatment administered to the training apparatus 606. The analyzer 118 may cause the processor(s) 614, in some examples, to output, to a region (e.g., the detection region 116) of a housing (e.g., the housing 108) of the training apparatus 606, a physical signal indicative of the artifacted physiological parameter.

### EXAMPLE CLAUSES

1. A medical device including: a housing configured to withstand a manual compression administered by a human; a sensor configured to detect the manual compression applied to the housing; and a processor configured to: identify a simulated electrocardiogram (ECG); generate a compression artifact associated with the manual compression; generate an artifacted ECG including the compression artifact; and cause an output device to output a signal indicative of the artifacted ECG.

2. The medical device of clause 1, wherein a Young's modulus of the housing is in a range of about 1 to about 10 gigapascal (GPa).

3. The medical device of clause 1 or 2, wherein the sensor includes an accelerometer, a speedometer, a pressure sensor, a force sensor, a linear potentiometer, or a variable resistor.

4. A medical device, including: a sensor configured to detect a force applied to a housing; and a processor configured to: identify parameter data indicative of a parameter sampled over a time interval; determine, by analyzing the force, an artifact; generate artifacted parameter data including the artifact; and cause an output device to output a signal indicative of the artifacted parameter data.

5. The medical device of clause 4, wherein the sensor includes an accelerometer, a speedometer, a pressure sensor, a force sensor, or a linear potentiometer.

6. The medical device of clause 5, wherein a resolution of the linear potentiometer is in a range of about 0.05 to about 0.5 centimeters (cm).

7. The medical device of any of clauses 4-6, further including: a detection circuit electrically connected to the sensor and including a variable resistor, wherein a resistance of the variable resistor corresponds to the force, and wherein determining, by analyzing the force, the artifact includes analyzing an output voltage of the variable resistor.

8 The medical device of any of clauses 4-7, wherein the parameter includes an ECG, a blood oxygen saturation, a regional saturation of oxygen, a blood pressure, a respiratory rate, a pulse rate, or end-tidal CO₂.

9. The medical device of any of clauses 4-8, wherein the force includes a compressive force administered by a human.

10. The medical device of any of clauses 4-9, wherein the processor is configured to determine, by analyzing the force, the artifact by determining at least one of: a magnitude, a time duration of the force, or a force release time duration.

11. The medical device of any of clauses 4-10, further including: an input device configured to receive a user input, wherein the processor is further configured to: generate filtered parameter data by applying a filter to the artifacted parameter data, the filter being configured to remove the artifact; and cause the output device to output a signal indicative of the filtered parameter data.

12. The medical device of any of clauses 4-11, wherein the artifact is a first artifact and the artifacted parameter data is first artifacted parameter data, the medical device further including: an input device configured to receive a user input, and wherein the processor is further configured to: determine a second artifact corresponding to a defibrillation shock; generate second artifacted parameter data including the second artifact; and cause the output device to output a signal indicative of the second artifacted parameter data.

13. A method including: identifying parameter data indicative of a parameter sampled over a time interval; identifying a force applied to a housing; determining, by analyzing the force, an artifact; generating artifacted parameter data including the artifact; and causing an output device to output a signal indicative of the artifacted parameter data.

14. The method of clause 13, wherein the parameter is indicative of an ECG, a blood oxygen saturation, a regional saturation of oxygen, a blood pressure, a respiratory rate, a pulse rate, or end-tidal CO₂.

15. The method of clause 13 or 14, wherein determining the artifact includes determining at least one of: a magnitude, a time duration of the force, or a force release time duration.

16. The method of any of clauses 13-15, wherein identifying the parameter includes receiving a first signal including a first voltage, and wherein the artifact includes a second voltage corresponding to the force applied to the housing.

17. The method of clause 16, wherein generating the artifacted parameter data includes adding the first voltage and the second voltage.

18. The method of any of clauses 13-17, wherein the signal is a first signal, and wherein identifying the force applied to the housing includes: receiving, from a sensor, a second signal indicative of the force applied to the housing.

19. The method of any of clauses 13-18, wherein the artifact is a first artifact and the artifacted parameter data is first artifacted parameter data, the method further including: identifying a user input; in response to identifying the user input, determining a second artifact corresponding to a defibrillation shock; generating second artifacted parameter data including the second artifact; and causing the output device to output a signal indicative of the second artifacted parameter data.

20. The method of any of clauses 13-19, further including: identifying a user input; in response to identifying the user input, generating filtered parameter data by applying a filter to the artifacted parameter data, the filter being configured to remove the artifact; and causing the output device to output a signal indicative of the filtered parameter data.

21. A medical device including: a housing including a detection region; a heart simulation circuit configured to output, at the detection region, a physical signal indicative of a simulated ECG; electrodes disposed on the detection region and configured to detect the physical signal indicative of the simulated ECG; a second sensor configured to detect a compressive force applied to the housing; and a processor configured to: identify ECG data representative of the simulated ECG; determine, by analyzing the compressive force, a chest compression artifact; generate artifacted ECG data by combining the ECG data and the chest compression artifact; and cause an output device to output a signal indicative of the artifacted ECG data.

22. The medical device of clause 21, wherein the detection region includes a conductive material.

23. The medical device of clause 21 or 22, wherein the physical signal includes a voltage, a current, or an impedance.

24. A medical device, including: a housing including a detection region; a simulation circuit configured to output a physical signal indicative of a simulated physiological parameter at the detection region; and a sensor configured to detect the physical signal indicative of the simulated physiological parameter.

25. The medical device of clause 24, wherein a Young's modulus of the housing is in a range of about 1 to about 10 gigapascal (GPa).

26. The medical device of clause 24 or 25, wherein a shape of the housing includes a shape of a human torso.

27. The medical device of any of clauses 24-26, wherein the detection region includes a conductive material.

28. The medical device of any of clauses 24-27, wherein physical signal includes a voltage, a current, or an impedance.

29. The medical device of any of clauses 24-28, wherein the simulated physiological parameter includes an ECG, a blood oxygen saturation, a blood pressure, a respiratory rate, a pulse rate, or end-tidal CO₂.

30. The medical device of any of clauses 24-29, wherein the simulated physiological parameter includes an ECG, wherein the detection region includes a plurality of subregions that are configured to output a plurality of physical signals including the physical signal, and wherein the sensor includes a plurality of electrodes disposed on the plurality of subregions.

31. The medical device of clause 30, wherein the sensor is connected to a monitor-defibrillator configured to output an electrical shock to housing.

32. The medical device of any of clauses 24-31, wherein the sensor is a first sensor, the medical device further including: a second sensor configured to detect a force applied to the housing.

33. The medical device of any of clauses 24-32, further including: a processor configured to: generate an artifact; generate an artifacted signal including the artifact; and cause the simulation circuit to output the artifacted signal as the physical signal.

34. The medical device of clause 33, wherein the processor is configured to generate the artifact by: identifying a force applied to the housing, an electrical shock applied to the housing, or a user input; and generating the artifact by analyzing the force applied to the housing, the electrical shock applied to the housing, or the user input.

35. A method, including: outputting, by a simulation circuit, a physical signal indicative of a simulated physiological parameter at a detection region of a housing that is receiving a compressive force; detecting, by a sensor, the physical signal; and outputting, by a detection circuit, a signal indicative of the physical signal.

36. The method of clause 35, wherein the simulated physiological parameter is indicative of an ECG, a blood oxygen saturation, a regional saturation of oxygen, a blood pressure, a respiratory rate, a pulse rate, or end-tidal CO₂.

37. The method of clause 35 or 36, wherein the physical signal includes a voltage, a current, or an impedance.

38. The method of any of clauses 35-37, wherein the detection region includes a conductive material.

39. The method of any of clauses 35-38, wherein outputting the signal indicative of the physical signal includes outputting, by an output device, a visual signal indicative of the physical signal.

40. The method of any of clauses 35-39, further including: identifying an artifact by detecting the compressive force; generating an artifacted signal including the artifact; and outputting, by the detection circuit, the artifacted signal as the signal indicative of the physical signal.

41. The method of clause 40, wherein identifying the artifact further includes: identifying an electrical shock applied to the housing or a user input; and generating the artifact by analyzing the electrical shock applied to the housing or the user input.

42. The method of clause 41, wherein the sensor is a first sensor, the method further including: receiving, from a second sensor, a signal indicative of the compressive force applied to the housing or the electrical shock applied to the housing.

43. The method of any of clauses 40-42, further including: determining a treatment decision based on analyzing the artifacted signal; and outputting, by an output device, an indication of the treatment decision.

44. The method of any of clauses 40-43, further including: generating a filtered signal by applying a filter to the artifacted signal, the filter being configured to remove the artifact; and outputting, by the detection circuit, the filtered signal.

45. The method of clause 44, further including: determining a treatment decision based on analyzing the filtered signal; and outputting, by an output device, an indication of the treatment decision.

46. A medical device including: a housing configured to withstand a manual compression administered by a human; electrodes configured to be disposed on the housing; a discharge circuit configured to output an electrical shock to the electrodes; an output device; an input device configured to receive a user input signal; and a processor configured to: identify a simulated electrocardiogram (ECG); identify a compression artifact in the simulated ECG, the compression artifact being associated with the manual compression; removing the compression artifact from the simulated ECG by applying a filter to the simulated ECG; in response to removing the compression artifact, identify a shockable arrhythmia in the ECG; cause the output device to output an indication of the shockable arrhythmia; and in response to receiving the user input signal, causing the discharge circuit to output the electrical shock to the housing.

47. The medical device of clause 46, wherein the electrodes are configured to be disposed on a treatment region of the housing, the treatment region being electrically connected to a surge protective device including at least one of: a resistor, a diode, or a fuse.

48. The medical device of clause 46 or 47, wherein an electrical impedance of the housing is in a range of about 20 Ohms to about 230 Ohms.

49. A medical device including: a housing configured to withstand an electrical shock; an output device; and a processor configured to: identify a simulated ECG; identify an artifact in the simulated ECG; in response to identifying the artifact, identify a shockable arrhythmia in the simulated ECG; and cause the output device to output a recommendation to administer the electrical shock to the housing.

50. The medical device of clause 49, wherein the housing is configured to withstand the electrical shock with an energy level up to 720 J.

51. The medical device of clause 49 or 50, wherein an electrical impedance of the housing is in a range of about 20 Ohms to about 230 Ohms.

52. The medical device of any of clauses 49-51, wherein the housing is configured to withstand a chest compression manually administered by a human.

53. The medical device of any of clauses 49-52, wherein identifying the shockable arrhythmia includes removing the artifact from the simulated ECG by applying a filter to the simulated ECG.

54. The medical device of any of clauses 49-53, wherein the artifact includes a compression artifact or a motion artifact.

55. The medical device of any of clauses 49-54, further including: electrodes configured to be disposed on the housing; a discharge circuit selectively outputting the electrical shock to the electrodes; and an input device, wherein the processor is further configured to: receive a user input signal from the input device; in response to receiving the user input signal, cause the output device to output an indication to stand clear of the housing; and cause the discharge circuit to output the electrical shock to the housing.

56. The medical device of clause 55, wherein the electrodes are first electrodes, the discharge circuit is a first discharge circuit, the electrical shock is a first electrical shock, and the user input signal is a first user input signal, the medical device further including: second electrodes configured to be disposed on the housing; and a second discharge circuit selectively outputting a second electrical shock to the second electrodes, wherein the processor is further configured to: receive a second user input signal from the input device; and cause the second discharge circuit to output the second electrical shock to the housing at a particular time relative to the first electrical shock.

57. The medical device of clause 55 or 56, wherein the electrodes are configured to be disposed on a treatment region of the housing, the medical device further including: a sensor configured to detect the electrical shock at the treatment region, wherein the processor is further configured to: determine, by analyzing the electrical shock, a treatment artifact; generate artifacted ECG data including the treatment artifact; and cause the output device to output a signal indicative of the artifacted ECG data.

58. A method including: identifying a force applied to a housing; removing an artifact corresponding to the force from a simulated ECG; in response to removing the artifact, identifying a shockable arrhythmia in the ECG; and in response to identifying the shockable arrhythmia, causing a discharge circuit to output an electrical shock to the housing.

59. The method of clause 58, wherein the housing is configured to withstand the electrical shock up to 720 J.

60. The method of clause 58 or 59, wherein the artifact includes a compression artifact or a motion artifact.

61. The method of any of clauses 58-60, wherein causing the discharge circuit to output the electrical shock includes: identifying a user input; and causing the discharge circuit to output the electrical shock to the housing.

62. The method of any of clauses 58-61, wherein the electrical shock is outputted at a treatment region, the treatment region being electrically connected to a surge protective device including at least one of: a resistor, a diode, or a fuse.

63. The method of any of clauses 58-62, wherein the electrical shock is a first electrical shock and the discharge circuit is a first discharge circuit, the method further including: causing a second discharge circuit to output a second electrical shock to the housing at a particular time relative to the first electrical shock.

64. The method of any of clauses 58-63, further including: detecting, by a sensor, the electrical shock administered to the housing; identifying a treatment artifact by detecting the electrical shock; generating an artifacted ECG including the treatment artifact; and outputting, by a detection circuit, the artifacted ECG.

65. The method of any of clauses 58-64, wherein the electrical shock is outputted to a treatment region of the housing, an electrical impedance of the treatment region being in a range of about 20 Ohms to about 230 Ohms, the method further including: detecting, from a detection region of the housing, a physical signal indicative of the simulated ECG at the detection region, the detection region comprising a material with an electrical impedance less than 10 Ohms.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be used for realizing implementations of the disclosure in diverse forms thereof.

As will be understood by one of ordinary skill in the art, each implementation disclosed herein can comprise, consist essentially of or consist of its particular stated element, step, or component. Thus, the terms “include” or “including” should be interpreted to recite: “comprise, consist of, or consist essentially of.” The transition term “comprise” or “comprises” means has, but is not limited to, and allows for the inclusion of unspecified elements, steps, ingredients, or components, even in major amounts. The transitional phrase “consisting of” excludes any element, step, ingredient or component not specified. The transition phrase “consisting essentially of” limits the scope of the implementation to the specified elements, steps, ingredients or components and to those that do not materially affect the implementation. As used herein, the term “based on” is equivalent to “based at least partly on,” unless otherwise specified.

Unless otherwise indicated, all numbers expressing quantities, properties, conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. When further clarity is required, the term “about” has the meaning reasonably ascribed to it by a person skilled in the art when used in conjunction with a stated numerical value or range, i.e. denoting somewhat more or somewhat less than the stated value or range, to within a range of ±20% of the stated value; ±19% of the stated value; ±18% of the stated value; ±17% of the stated value; ±16% of the stated value; ±15% of the stated value; ±14% of the stated value; ±13% of the stated value; ±12% of the stated value; ±11% of the stated value; ±10% of the stated value; ±9% of the stated value; ±8% of the stated value; ±7% of the stated value; ±6% of the stated value; ±5% of the stated value; ±4% of the stated value; ±3% of the stated value; ±2% of the stated value; or ±1% of the stated value.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements.

The terms “a,” “an,” “the” and similar referents used in the context of describing implementations (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate implementations of the disclosure and does not pose a limitation on the scope of the disclosure. No language in the specification should be construed as indicating any non-claimed element essential to the practice of implementations of the disclosure.

Groupings of alternative elements or implementations disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain implementations are described herein, including the best mode known to the inventors for carrying out implementations of the disclosure. Of course, variations on these described implementations will become apparent to those of ordinary skill in the art upon reading the foregoing description. The inventors expect skilled artisans to employ such variations as appropriate, and the inventors intend for implementations to be practiced otherwise than specifically described herein. Accordingly, the scope of this disclosure includes all modifications and equivalents of the subject matter recited in the claims appended hereto as permitted by applicable law. Moreover, any combination of the above-described elements in all possible variations thereof is encompassed by implementations of the disclosure unless otherwise indicated herein or otherwise clearly contradicted by context.

1. A medical device comprising:
a housing configured to withstand a manual compression administered by a human;
a sensor configured to detect the manual compression applied to the housing; and
a processor configured to:
identify a simulated electrocardiogram (ECG);
generate a compression artifact associated with the manual compression;
generate an artifacted ECG comprising the compression artifact; and
cause an output device to output a signal indicative of the artifacted ECG.

2. The medical device of claim 1, wherein a Young's modulus of the housing is in a range of about 1 to about 10 gigapascal (GPa).

3. The medical device of claim 1, wherein the sensor comprises an accelerometer, a speedometer, a pressure sensor, a force sensor, a linear potentiometer, or a variable resistor.

4. A medical device, comprising:
a sensor configured to detect a force applied to a housing; and
a processor configured to:
identify parameter data indicative of a parameter sampled over a time interval;
determine, by analyzing the force, an artifact;
generate artifacted parameter data comprising the artifact; and
cause an output device to output a signal indicative of the artifacted parameter data.

5. The medical device of claim 4, wherein the sensor comprises an accelerometer, a speedometer, a pressure sensor, a force sensor, or a linear potentiometer.

6. The medical device of claim 5, wherein a resolution of the linear potentiometer is in a range of about 0.05 to about 0.5 centimeters (cm).

7. The medical device of claim 4, further comprising:
a detection circuit electrically connected to the sensor and comprising a variable resistor, wherein a resistance of the variable resistor corresponds to the force, and
wherein determining, by analyzing the force, the artifact comprises analyzing an output voltage of the variable resistor.

8. The medical device of claim 4, wherein the parameter comprises an ECG, a blood oxygen saturation, a regional saturation of oxygen, a blood pressure, a respiratory rate, a pulse rate, or end-tidal CO₂.

9. The medical device of claim 4, wherein the force comprises a compressive force administered by a human.

10. The medical device of claim 4, wherein the processor is configured to determine, by analyzing the force, the artifact by determining at least one of: a magnitude, a time duration of the force, or a force release time duration.

11. The medical device of claim 4, further comprising:
an input device configured to receive a user input,
wherein the processor is further configured to:
generate filtered parameter data by applying a filter to the artifacted parameter data, the filter being configured to remove the artifact; and
cause the output device to output a signal indicative of the filtered parameter data.

12. The medical device of claim 4, wherein the artifact is a first artifact and the artifacted parameter data is first artifacted parameter data, the medical device further comprising:
an input device configured to receive a user input, and
wherein the processor is further configured to:
determine a second artifact corresponding to a defibrillation shock;
generate second artifacted parameter data comprising the second artifact; and
cause the output device to output a signal indicative of the second artifacted parameter data.

13. A method comprising:
identifying parameter data indicative of a parameter sampled over a time interval;
identifying a force applied to a housing;
determining, by analyzing the force, an artifact;
generating artifacted parameter data comprising the artifact; and
causing an output device to output a signal indicative of the artifacted parameter data.

14. The method of claim 13, wherein the parameter is indicative of an ECG, a blood oxygen saturation, a regional saturation of oxygen, a blood pressure, a respiratory rate, a pulse rate, or end-tidal CO₂.

15. The method of claim 13, wherein determining the artifact comprises determining at least one of: a magnitude, a time duration of the force, or a force release time duration.

16. The method of claim 13, wherein identifying the parameter comprises receiving a first signal comprising a first voltage, and
wherein the artifact comprises a second voltage corresponding to the force applied to the housing.

17. The method of claim 16, wherein generating the artifacted parameter data comprises adding the first voltage and the second voltage.

18. The method of claim 13, wherein the signal is a first signal, and
wherein identifying the force applied to the housing comprises:
receiving, from a sensor, a second signal indicative of the force applied to the housing.

19. The method of claim 13, wherein the artifact is a first artifact and the artifacted parameter data is first artifacted parameter data, the method further comprising:
identifying a user input;
in response to identifying the user input, determining a second artifact corresponding to a defibrillation shock;
generating second artifacted parameter data comprising the second artifact; and
causing the output device to output a signal indicative of the second artifacted parameter data.

20. The method of claim 13, further comprising:
identifying a user input;
in response to identifying the user input, generating filtered parameter data by applying a filter to the artifacted parameter data, the filter being configured to remove the artifact; and
causing the output device to output a signal indicative of the filtered parameter data.
